(19) United States
(12) Patent Application Publication
(10) Pub. No.: US 2015/0068464 A1
(43) Pub. Date: Mar. 12, 2015

(54) PORTABLE DRINK CONTAINER

(71) Applicant: Jason Worry, Palo Alto, CA (US)

(72) Inventor: Jason Worry, Palo Alto, CA (US)

(21) Appl. No.: 14/023,882

(22) Filed: Sep. 11, 2013

(51) Int. Cl. A01K 7/00; A01K 29/00

(52) U.S. Cl. CPC A01K 7/005; A01K 29/00
USPC 119/72; 53/492

(57) ABSTRACT

A method of operating a container system for providing a hydrating liquid solution to a pet includes: providing a front side including a peripheral seal, the front side coupled to a back side and to peripheral sides for containing the hydrating liquid solution; and breaking the peripheral seal to expose the hydrating liquid solution from a top of the container system.

### FIELD OF THE INVENTION

The field of the invention is related to pet care, in particular to a portable nutritious water drink and container for animals, such as dogs and cats.

### BACKGROUND OF THE INVENTION

Around the world pets fulfill a vital importance in the lives of many pet owners. Caring for pets has become an increasingly refined and necessary part of pet ownership. Today more than ever, pets are traveling with its owners on airplanes, automobiles, in addition to normal daily walks.

A solution to provide clean, nutritious, hydration for pets in a format that allows clean and efficient consumption on the go, has eluded those of ordinary skill in the art. Many attempts to solve this problem have been made but none have yet been able to provide a full solution to this problem.

Currently, some products exist that allow the pet owner to attach a tray to a water bottle in order to conveniently provide drinking water to its pets. This partial solution fails to provide a system allowing for the differing nutrition in needs between a pet and their owner. Further, this solution fails to provide a clean and efficient solution but instead requires the pet owner to fill a tray which commonly leads to spillage or splashing and waste not to mention this solution is much less mobile requiring many individualized steps and components to accomplish the task of hydrating a pet.

Other products involve attaching a nozzle device to the water bottle for the pet to drink from. This solution is not portable because the pet owner is required to carry multiple items (e.g. water bottle and tray or nozzle attachment etc . . . ) which cannot be easily discarded after use.

In addition, previous attempts fail to solve the problem arising when an adequate drinking supply is not available. Many owners allow their pets to drink from a near-by water source, such as a lake, pool, or water fountain.

These sources are unsanitary and pose health risks to the animals due to potential bacteria, harmful chemicals, and other toxins found in standing water. Thus the need to provide a convenient, portable, sanitary and nutritious drink that that is self-contained in an appropriate format has been long sought by those skilled in the art.

Prior developments have not taught or suggested any solutions to overcome all of the limitations described above, and thus, solutions to overcome these limitations have long eluded those skilled in the art.

### SUMMARY OF THE INVENTION

The present invention provides a method of operating a container system for providing a hydrating liquid solution to a pet comprising including: providing a front side including a peripheral seal, the front side coupled to a back side and to peripheral sides for containing the hydrating liquid solution; and breaking the peripheral seal to expose the hydrating liquid solution from a top of the container system.

The present invention provides a container system for providing a hydrating liquid solution to a pet comprising including: a front side including a peripheral seal, the peripheral seal configured to be breakable to expose the hydrating liquid solution from a top of the container system; and a back side coupled to the front side and to peripheral sides for containing the hydrating liquid solution.

The present invention provides a portable container containing a nutritious drinking water that solves the problems of allowing pet owners a convenient and sanitary way to provide drinking water to their pets.

In one embodiment, the present invention can provide a sanitary and healthy drink solution to pet animals.

In another embodiment, the present invention can to provide a container that allows pets to drink the water based solution in a normal licking fashion.

In another embodiment, the present invention can provide an all in one drinking solution for pet animals.

In another embodiment, the present invention can provide a container that is capable of being resealed to prevent spillage of the water based solution during transportation and to prolong the freshness of the drinking solution.

In another embodiment, the invention can provide a container and water based drinking solution that is relatively inexpensive to manufacture and is environmentally friendly when discarded.

The present invention further includes other aspects in addition to or in place of those mentioned above. These aspects will become apparent to those skilled in the art from a reading of the following detailed description of the preferred embodiments when taken with reference to the accompanying drawings.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a front view of a container system in a first embodiment of the present invention.

FIG. 2 is a side view of the container system of FIG. 1.

FIG. 3 is a back view of the container system of FIG. 1.

FIG. 4 is a cross-sectional view of the container system of FIG. 3 along the line 4-4.

FIG. 5 is an isometric view of multiple container systems of FIG. 1.

FIG. 6 is a front view of a container system in a second embodiment of the present invention.

FIG. 7 is an isometric view of a container system in a third embodiment of the present invention.

FIG. 8 is an isometric view of a container system in a fourth embodiment of the present invention.

FIG. 9 is a flow chart of a method of operation of the container system in an embodiment of the present invention.

### DETAILED DESCRIPTION OF THE PREFERRED EMBODIMENTS

In the following description of the embodiments of the invention, reference is made to the accompanying drawings that form a part hereof, and in which are shown by way of illustration, exemplary embodiments in which the invention may be practiced. It is to be understood that other embodiments may be utilized and structural changes may be made without departing from the scope of the present invention.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention; however, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Generally, the invention can be operated in any orientation.

In addition, where multiple embodiments are disclosed and described having some features in common, for clarity and ease of illustration, description, and comprehension thereof, similar and like features one to another will ordinarily be described with like reference numerals. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the front side, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “processing” as used herein includes deposition of material, patterning, exposure, development, etching, cleaning, molding, and/or removal of the material or as required in forming a described structure. The term “system” as used herein means and refers to the method and to the apparatus of the present invention in accordance with the context in which the term is used.

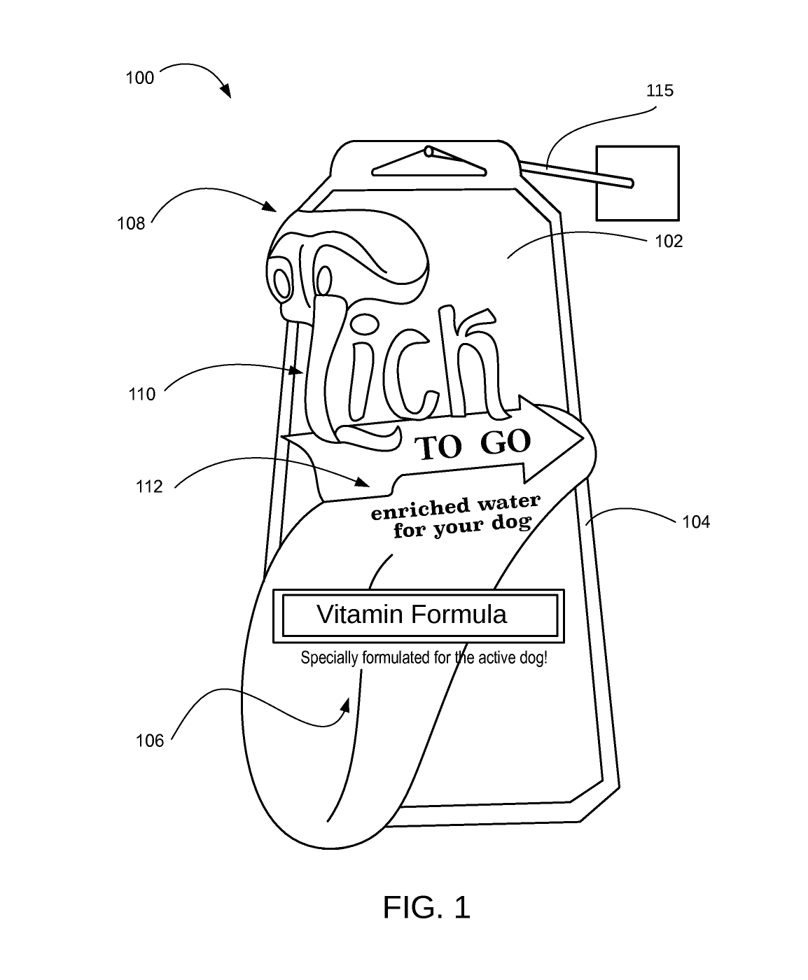

Referring now to FIG. 1, therein is shown a front view of a container system 100 in a first embodiment of the present invention. The container system 100 can be a disposable plastic container prefilled with a hydrating fluid solution. It is also contemplated that the container system 100 can be a resalable or reusable container for storage, transport and delivery of a hydrating fluid solution.

The container system 100 is contemplated to be used in the pet care industry. However, it is to be clearly noted that the container system 100 may be applied to other industries as well where a portable container containing a hydrating fluid solution, such as a nutritious water drink, would be beneficial. In the application of the pet care industry, each container system 100 may be manufactured in a way that is portable and can be stored and carried very easily.

The container system 100 is shown having a front side 102. The front side 102 can be a resealable or disposable. The front side 102 can be a film or a structured lid. The shape of the front side 102 of the container system 100 can be roughly trapezoidal narrowing toward a top of the front side 102. The container system 100 can be shaped to have an aspect ratio of more than 1:2 for some applications.

It has been discovered that the aspect ratio of more than 1:2 allows for easier storage and provides the unexpected benefit of allowing animals with narrow muzzles to have a higher consumption rate while simultaneously wasting less of the hydrating liquid solution contained therein. It has also been discovered that the shape of the container system 100, narrowing near a top and widening near a bottom of the front side 102, unexpectedly increases the consumption rate while simultaneously decreases the amount of liquid that is spilled or splashed out while an animal is drinking.

It is contemplated that the shape, aspect ratio, and amount of taper of the container system 100 can be directly correlated to the features of an animal such as a length and width of the animal's muzzle or tongue. The shape, taper, and aspect ratio of the container system 100 allows for animals to drink naturally by licking down into the container system 100 preserving the lateral movement of the tongue while providing a compact transportable container.

The front side 102 can include a peripheral seal 104 generally along a periphery of the front side 102. The peripheral seal 104 can provide a water tight seal for the hydrating liquid solution keeping the hydrating liquid solution fresh and prevent spillage during transportation.

The front side 102 is designed to be opened only partially leaving some of the front side 102 attached to the container system 100 to act as a splash guard preventing the hydrating liquid solution from splashing out of the container system 100. The front side 102 can further include markings 106 such as symbols 108, logos 110, and descriptions 112.

The symbols 108 are depicted as a dog nose and tongue. Other manifestations are contemplated such as a cat tongue and nose, or other animal facial features. The symbols 108 can over hang the peripheral seal 104 of the front side 102.

The symbols 108 are shown overhanging the peripheral seal 104 at multiple points. The symbol 108 depicting the dog tongue is shown overhanging the peripheral seal 104: along a right portion of the front side 102 near a root of the dog tongue, along a bottom left portion of the front side 102 near a tip of the dog tongue, and along a left portion of the front side 102 near a middle section of the dog tongue.

The symbol 108 depicting the dog nose is shown overhanging the peripheral seal 104 along a left top portion of the front side 102. The symbols 108 extending beyond the peripheral seal 104 can be used as a quick or easy opening mechanism. The symbols 108 overhanging the peripheral seal 104 can be pulled on to release the front side 102 from the container system 100 and to expose the hydrating fluid solution for use or consumption.

The front side 102 can be peeled off the container system 100 by pulling on one of the symbols 108 overhanging the peripheral seal 104 to allow the front side 102 to be partially unsealed from the bottom, left, or right side while remaining sealed on the along the same and other sides to accommodate or control the rate of consumption at which an animal can consume the hydrating liquid solution. Alternatively, the front side 102 can be completely removed from the peripheral seal 104 of the container system 100.

The logos 110 can be centered on the front side 102 and placed between the symbols 108. The logos 110 can extend over the peripheral seal 104 but are not depicted as extending beyond the peripheral seal 104. In other contemplated embodiments, the logos 110 can extend beyond the peripheral seal 104 to provide an easy opening solution or can be fully contained within the peripheral seal 104.

The descriptions 112 are depicted as contained fully within the peripheral seal 104 near the logos 110 and over the symbols 108. The descriptions 112 can be used for easy classification, storage and use of the container system 100 when multiple container systems 100 of differing contents are used, stored, or transported.

The front side 102 further includes an integral hang tab 114 near the top of the front side 102 and exterior to the peripheral seal 104. The integral hang tab 114 can be attached to a carabineer or used to store the container system 100 on a hanger. The integral hang tab 114 can also be folded down for a more compact transportation within a handbag or a backpack.

In typical use, an owner would carry one or more of the container systems 100 with the hydrating fluid solution of the present invention either by hand or have them placed in a separate carrying bag, such as a purse, for convenience purposes. When desired, the owner would simply place the container system 100 with the hydrating fluid solution of the present invention on the ground and remove the front side 102 either completely or partially if re-sealing of the container system 100 is desired. The pet would then simply drink the hydrating fluid solution by licking the contents contained in the container system 100. When the pet is finished drinking, the owner would either throw the entire container system 100 away or re-seal it for future use if for instance the pet did not drink the entire hydrating fluid solution in one sitting.

It is also contemplated that the container system 100 with the hydrating fluid solution of the present invention may be sold in convenient locations where pet owners typically walk their dogs such as parks and recreational areas. In one preferred embodiment, the present invention would be sold in a vending type of machine that a pet owner could easily pay for and receive one or more of the container systems 100 with the hydrating fluid solution of the present invention. Alternatively, it is also contemplated that cities and entire states could pre-purchase a large quantity of the container systems 100 with the hydrating fluid solution of the present invention and provides them to pet owners for free.

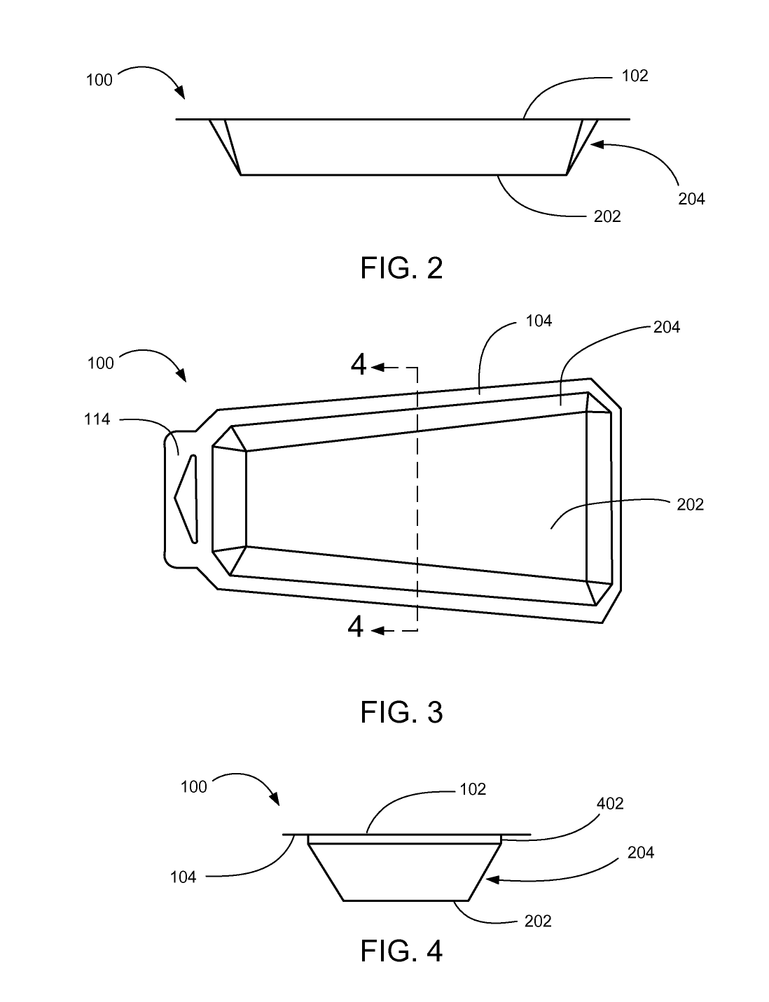

Referring now to FIG. 2, therein is shown a side view of the container system 100 of FIG. 1. The container system 100 is shown having the front side 102 a back side 202 and peripheral sides 204.

The front side 102 and the back side 202 are shown parallel to each other for ease of storage. The back side 202 can be flat to accommodate the use of the container system 100 on a flat surface such as the ground. The front side 102 is shown substantially larger than the back side 202 and overhangs the back side 202. The front side 102 can be larger to ensure a proper water tight seal is provided.

The peripheral sides 204 are shown extending between the back side 202 to the front side 102 at an angle. The peripheral sides 204 widen as they extend toward the front side 102. The front side 102 is shown overhanging the peripheral sides 204 even as the peripheral sides 204 widen toward the front side 102.

The angle of the peripheral sides 204 can accommodate the tapered shape of an animal's tongue by providing more surface area near the front side 102 to wet the tongue and less near the back side 202. The peripheral sides 204 can also be connected at angles less than 90 degrees to allow complete access for a tongue to consume all the hydrating liquid solution within the container system 100 and leaving no inaccessible areas of the container system 100.

The top and bottom of the peripheral sides 204 meet the front side 102 with a continuous flat side without an edge or lip. It has been discovered that the absence of any purturbance as the top and bottom of the peripheral sides 204 meet the front side 102 unexpectedly reduces splash during drinking by eliminating oscillatory movement in the tongue of a drinking animal.

Referring now to FIG. 3, therein is shown a back view of the container system 100 of FIG. 1. The back side 202 is shown circumscribed by the peripheral sides 204. The peripheral sides 204 and the back side 202 are shown circumscribed by the peripheral seal 104.

The back side 202 is shown as flat but it is contemplated that the back side 202 can be indented in the middle to provide greater stability when the container system 100 is set on an uneven or bumpy surface.

The peripheral seal 104 is shown with the front side 102 of FIG. 1 completely removed in one drinking configuration. The symbols 108 of FIG. 1 that were overhanging the peripheral seal 104 are no longer visible after the front side 102 was removed. The back side 202 is shown having an even higher aspect ratio than the front side 102. The peripheral sides 204 have a greater slant near the top of the container system 100 than at the bottom.

The peripheral sides 204 can be slanted or tapered from the back side 202 to the front side 102 at differing slants to provide the most efficient access and to the hydrating liquid solution. The peripheral sides 204 are depicted having a greater slant (more lateral distance compared to the vertical distance) near the top, close to the integral hang tab 114. The slant of the peripheral sides 204 near the bottom is less (less lateral distance compared to the vertical distance).

Referring now to FIG. 4, therein is shown a cross-sectional view of the container system 100 of FIG. 3 along the line 4-4. The peripheral sides 204 on the left and right side of the container system 100 are shown extending from the back side 202 to the front side 102. Near the front side 102, the peripheral sides 204 form a vertical lip 402 before contacting the front side 102 at a ninety degree angle. The peripheral seal 104 of the front side 102 can contact the vertical lip 402. It is further contemplated that the peripheral seal 104 can be peripheral to the vertical lip 402.

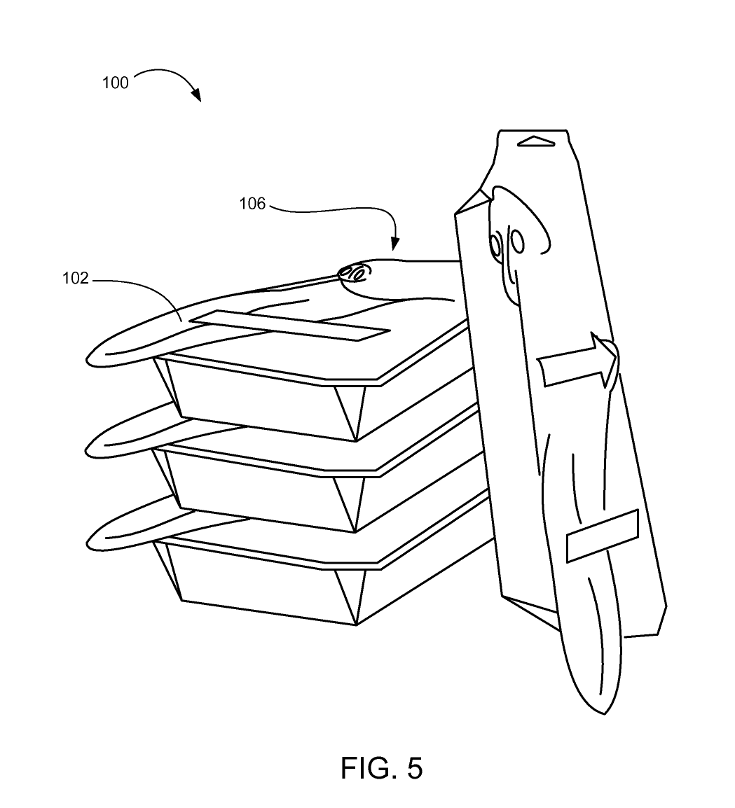

Referring now to FIG. 5, therein is shown an isometric view of multiple container systems 100 of FIG. 1. The container systems 100 are shown stacked and demonstrate the ease of storage or the ease of transport. The container systems 100 can be identifiable as to the contents without unstacking when the markings 106 are not covered by the back side 202 of FIG. 2.

The unique shape of the container system 100 is shown by the ability to efficiently handle and categorize the container system 100 when stacked since the markings 106, including the symbols 108 of FIG. 1, the descriptions 112 of FIG. 1, and the logos 110 of FIG. 1, are visible on the front side 102 of the container system 100.

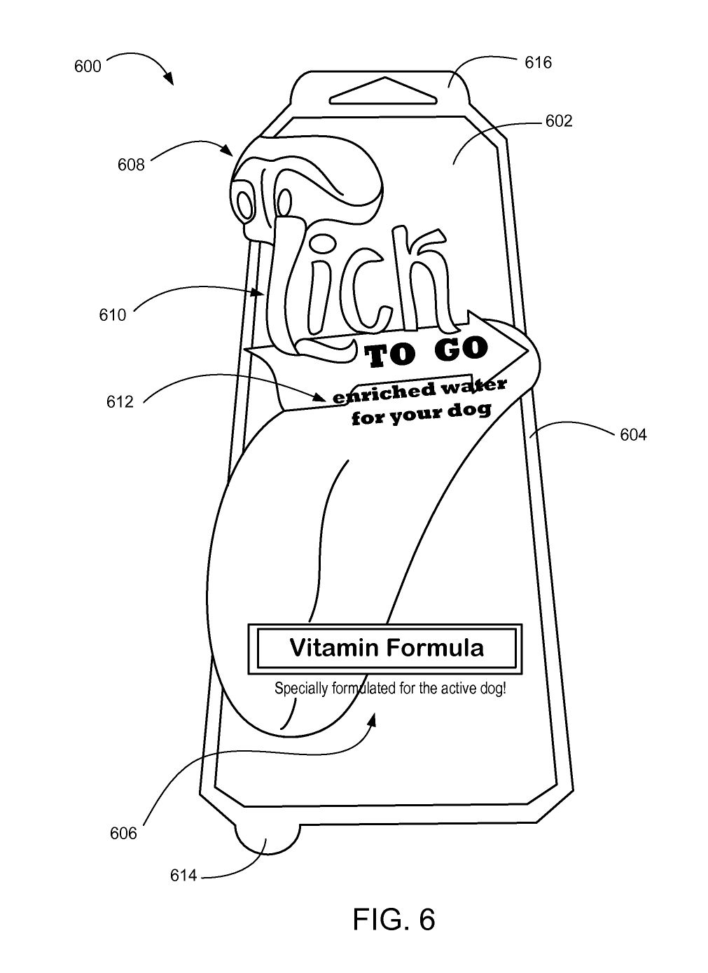

Referring now to FIG. 6, therein is shown a front view of a container system 600 in a second embodiment of the present invention. The container system 600 can be a disposable plastic container prefilled with a hydrating fluid solution. It is also contemplated that the container system 600 can be a resalable or reusable container for storage, transport and delivery of a hydrating fluid solution.

The container system 600 is contemplated to be used in the pet care industry. However, it is to be clearly noted that the container system 600 may be applied to other industries as well where a portable container containing a nutritious water drink would be beneficial. In the application of the pet care industry, each container system 600 may be manufactured in a way that is portable and can be stored and carried very easily.

The container system 600 is shown having a front side 602. The front side 602 can be a resealable or disposable. The front side 602 can be a film or a structured lid. The shape of the front side 602 of the container system 600 can be roughly trapezoidal narrowing toward a top of the front side 602. The container system 600 can be shaped to have an aspect ratio of more than 1:2.5 for some applications.

It has been discovered that the aspect ratio of more than 1:2.5 allows for easier storage and provides the unexpected benefit of allowing animals with narrow muzzles to have a higher consumption rate while simultaneously wasting less of the hydrating liquid solution contained therein. It has also been discovered that the shape of the container system 600, narrowing near a top and widening near a bottom of the front side 602, unexpectedly increases the consumption rate while simultaneously decreases the amount of liquid that is spilled or splashed out while an animal is drinking.

It is contemplated that the shape, aspect ratio, and amount of taper of the container system 600 can be directly correlated to the features of an animal such as a length and width of the animal's muzzle or tongue. As an example, the container system 600 is configured to suit a longer narrower muzzle or tongue than the container system 100 of FIG. 1. The shape, taper, and aspect ratio of the container system 600 allows for animals to drink naturally by licking down into the container system 600 preserving the lateral movement of the tongue while providing a compact transportable container.

The front side 602 can include a peripheral seal 604 generally along a periphery of the front side 602. The peripheral seal 604 can provide a water tight seal for the hydrating liquid solution keeping the hydrating liquid solution fresh and prevent spillage during transportation.

The front side 602 is designed to be opened only partially leaving some of the front side 602 attached to the container system 600 to act as a splash guard preventing the hydrating liquid solution from splashing out of the container system 600. The front side 602 can further include markings 606 such as symbols 608, logos 610, and descriptions 612.

The symbols 608 are depicted as a dog nose and tongue. Other manifestations are contemplated such as a cat tongue and nose, or other animal facial features. The symbols 608 can over hang the peripheral seal 604 of the front side 602.

The symbols 608 are shown overhanging the peripheral seal 604 at multiple points. The symbol 608 depicting the dog tongue is shown overhanging the peripheral seal 604 along a right portion of the front side 602 near a root of the dog tongue and along a left portion of the front side 602 near a middle section of the dog tongue.

The symbol 608 depicting the dog nose is shown overhanging the peripheral seal 604 along a left top portion of the front side 602. The symbols 608 extending beyond the peripheral seal 604 can, along with a pull tab 614 near a bottom of the front side 602, be used as a quick or easy opening mechanism. The symbols 608 overhanging the peripheral seal 604 can be pulled on to release the front side 602 from the container system 600 and to expose the hydrating fluid solution for use or consumption.

The front side 602 can be peeled off the container system 600 by pulling on one of the symbols 608 overhanging the peripheral seal 604 or the pull tab 614 to allow the front side 602 to be partially unsealed from the bottom, left, or right side while remaining sealed on the along the same and other sides to accommodate or control the rate of consumption at which an animal can consume the hydrating liquid solution. Alternatively, the front side 602 can be completely removed from the peripheral seal 604 of the container system 600.

The logos 610 can be centered on the front side 602 and placed between the symbols 608. The logos 610 can extend over the peripheral seal 604 but are not depicted as extending beyond the peripheral seal 604. In other contemplated embodiments, the logos 610 can extend beyond the peripheral seal 604 to provide an easy opening solution or can be fully contained within the peripheral seal 604.

The descriptions 612 are depicted as contained fully within the peripheral seal 604 near the logos 610 and over the symbols 608. The descriptions 612 can be used for easy classification, storage and use of the container system 600 when multiple container systems 600 of differing contents are used, stored, or transported.

The front side 602 further includes an integral hang tab 616 near the top of the front side 602 and exterior to the peripheral seal 604. The integral hang tab 616 can be attached to a carabineer or used to store the container system 600 on a hanger. The integral hang tab 616 can also be folded down for a more compact transportation within a handbag or a backpack.

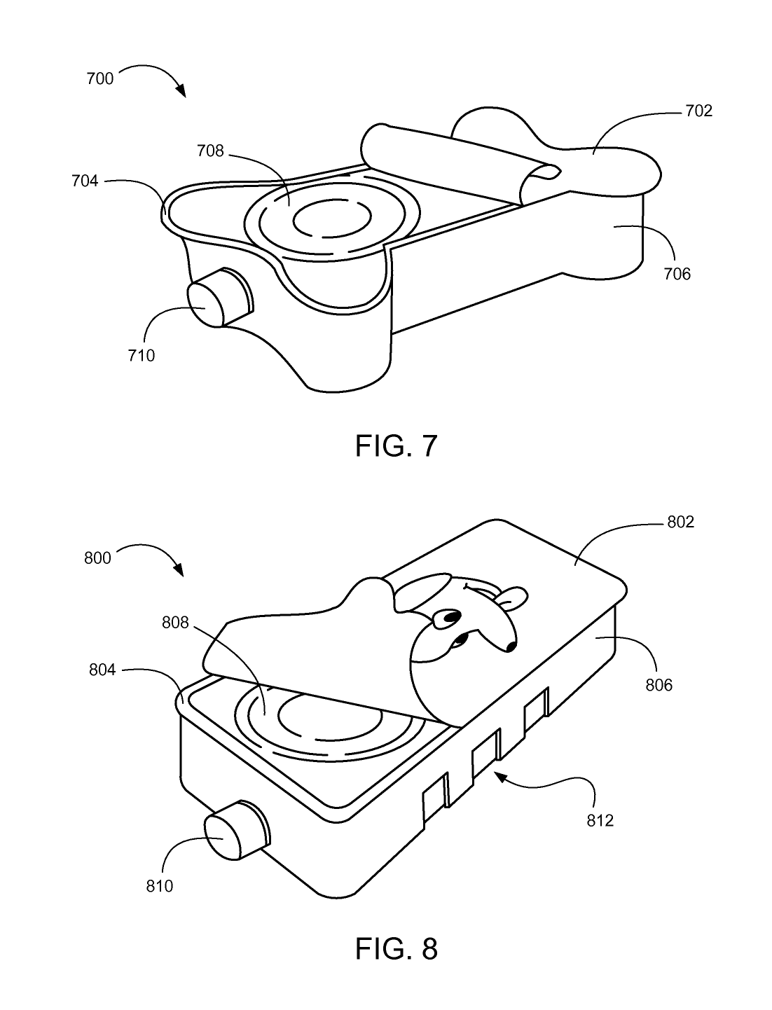

Referring now to FIG. 7, therein is shown an isometric view of a container system 700 in a third embodiment of the present invention. The container system 700 is shown having a front side 702 coupled to the container system 700 with a peripheral seal 704.

The peripheral seal 704 is connected to peripheral sides 706. The peripheral sides 706 can extend down away from the front side 702 vertically or can extend at a slant. The container system 700 is shown including a hydrating liquid solution 708. The hydrating liquid solution 708 can comprise water and other nutrients, including vitamins that are specifically designed to hydrate pet animals, such as dogs and cats.

Along the peripheral sides 706, a nozzle 710 can be included that allows the hydrating liquid solution 708 to be poured out without removing the front side 702 of the container. The front side 702 is shown partially opened and partially closed. The container system 700 can be shaped as a dog bone. It has been discovered that providing the shape of a bone unexpectedly allows for increased grip on the container system 700 when aggressively handling the container system 700.

Referring now to FIG. 8, therein is shown an isometric view of a container system 800 in a fourth embodiment of the present invention. The container system 800 is shown having a front side 802 coupled to the container system 800 with a peripheral seal 804.

The peripheral seal 804 is connected to peripheral sides 806. The peripheral sides 806 can extend down away from the front side 802 vertically or can extend at a slant. The container system 800 is shown including a hydrating liquid solution 808. The hydrating liquid solution 808 can comprise water and other nutrients, including vitamins that are specifically designed to hydrate pet animals, such as dogs and cats.

Along the peripheral sides 806, a nozzle 810 can be included that allows the hydrating liquid solution 808 to be poured out without removing the front side 802 of the container. The front side 802 is shown partially opened and partially closed. The peripheral sides 806 of the container system 800 can include grip ridges 812 near a back side of the container system 800 for increased grip.

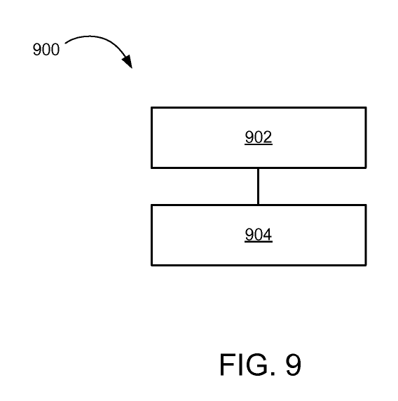

Referring now to FIG. 9, therein is shown a flow chart of method of operation 900 of the container system 100 in an embodiment of the present invention. The method of operating a container system for providing a hydrating liquid solution to a pet includes: providing a front side including a peripheral seal, the front side coupled to a back side and to peripheral sides for containing the hydrating liquid solution in a block 902; and breaking the peripheral seal to expose the hydrating liquid solution from a top of the container system in a block 904.

Thus, it has been discovered that the container system, method, and apparatus of the present invention furnish important and heretofore unknown and unavailable solutions, capabilities, and functional aspects.

The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description.

Accordingly, it is intended to embrace all such alternatives, modifications, and variations, which fall within the scope of the included claims. All matters set forth herein or shown in the accompanying drawings are to be interpreted in an illustrative and non-limiting sense.

1. A method of operating a container system for providing a hydrating liquid solution to a pet comprising:
providing a front side including a peripheral seal, a symbol, a pull tab, and a hang tab, the symbol and the pull tab overhanging the peripheral seal and configured to independently allow the front side to be detached from the container system, the front side coupled to a back side and to peripheral sides, and the hang tab having an internal surface configured to contact a storage support and the hang tab configurable to extend coplanar with the front side and beyond all the peripheral sides; and
breaking the peripheral seal to expose the hydrating liquid solution from a top of the container system.

2. The method of claim 1 wherein providing the front side includes providing the front side that is resealable, non-resealable, or a combination thereof

3. The method of claim 1 wherein breaking the peripheral seal exposing the hydrating liquid solution includes exposing the hydrating liquid solution that includes a water-based solution having nutrients.

4. The method of claim 1 further comprising filling or draining the container system with a nozzle included in the container system.

5. The method of claim 1 wherein providing the front side includes providing the front side having an aspect ratio of greater than 1:2.

6. A method of operating a container system for providing a hydrating liquid solution to a pet comprising:
providing a front side including a peripheral seal and a symbol, a logo, or a description that can be seen when the container system is stacked, the front side further including a pull tab, and a hang tab, the symbol and the pull tab overhanging the peripheral seal and configured to independently allow the front side to be detached from the container system, the front side coupled to a back side and to peripheral sides, and the hang tab having an internal surface configured to contact a storage support and the hang tab configurable to extend coplanar with the front side and beyond all the peripheral sides; and
breaking the peripheral seal to expose the hydrating liquid solution from a top of the container system.

7. The method of claim 6 wherein providing the front side includes providing the front side with the logo extending over the peripheral seal.

8. (canceled)

9. The method of claim 6 wherein providing the front side includes providing the front side shaped like a square, a trapezoid, a bone, or a combination thereof

10. The method of claim 6 wherein providing the front side includes providing the front side having the hang tab configured to fold for compact transport.

11. A container system for providing a hydrating liquid solution to a pet comprising:
a front side including a peripheral seal, a symbol, a pull tab, and a hang tab, the symbol and the pull tab overhanging the peripheral seal and configured to independently allow the front side to be detached from the container system, the peripheral seal configured to be breakable to expose the hydrating liquid solution from a top of the container system;
a back side coupled to the front side and to peripheral sides for containing the hydrating liquid solution; and
wherein the hang tab has an internal surface configured to contact a storage support and the hang tab configurable to extend coplanar with the front side and beyond all the peripheral sides.

12. The system of claim 11 wherein the front side that is resealable, non-resealable, or a combination thereof.

13. The system of claim 11 wherein the hydrating liquid solution is a water-based solution having nutrients.

14. The system of claim 11 further comprising a nozzle configured to fill or drain the container system.

15. The system of claim 11 wherein the front side has an aspect ratio of greater than 1:2.

16. The system of claim 11 wherein the front side includes the symbol, a logo, or a description that can be seen when the container system is stacked.

17. The system of claim 16 wherein the logo extends over the peripheral seal.

18. (canceled)

19. The system of claim 16 wherein the front side is shaped like a square, a trapezoid, a bone, or a combination thereof.

20. The system of claim 16 wherein the hang tab is configured to fold for transport.
